(19) United States
(12) Patent Application Publication
(10) Pub. No.: US 2012/0187653 A1
(43) Pub. Date: Jul. 26, 2012

(54) FULL SUSPENSION LOCK-OUT FOR A MOUNTAIN BIKE THAT SLIDES IN, IN PLACE OF THE REAR SHOCK

(76) Inventors: Christopher M. Edgeworth, Longview, TX (US); Ronald A. Johnston, Longview, TX (US)

(21) Appl. No.: 13/013,726

(22) Filed: Jan. 25, 2011

(51) Int. Cl. B62K 19/30; F16F 9/00

(52) U.S. Cl. 280/283

(57) ABSTRACT

A means is provided to allow the lockout or replacement of the rear suspension of a mountain bike to increase peddling efficiency while climbing grades or other heavy pedaling conditions.

### FIELD OF THE INVENTION

This present invention relates to locking out the rear suspension of a mountain bicycle for certain biking conditions where the rear suspension system may have a detrimental affect on biking efficiency.

### BACKGROUND

Many bicycles today have a suspension system to let wheels move up and down to absorb bumps while keeping the tires in contact with the ground. This may give better control and also protect the rider from feeling every bump and dip during a ride over rough terrain. Both the front and rear suspension systems contain two essential elements: a spring and a damper. The rear suspension is the topic this invention addresses. As a rider is pedaling the bicycle uphill, some of the force exerted from the pedal sprocket to the rear sprocket, may compress the shock absorber mechanism. This part of the energy is therefore not utilized in actually moving the bicycle up the hill. It therefore may be advantageous to lockout the shock absorber mechanism for uphill climbing or other specified riding conditions.

There is thus a need for addressing these and/or other issues associated with the prior art.

### SUMMARY

A means is provided to allow the lockout or replacement of the rear suspension of a mountain bike to increase peddling efficiency while climbing grades or other heavy pedaling conditions.

### BRIEF DESCRIPTION OF THE DRAWINGS

FIG. 1 shows the layout of the a typical bicycle and identifies the main frame and rear frame of the bicycle, the coupling mechanism for mounting the shock absorber, the placement of a shock absorber, and a pivot or movable point between the main and rear frame structures. It also shows a possible lockout mechanism.

FIG. 2 shows the compression of the shock absorber when the rear wheel hits a bump in the road. It also shows the lockout mechanism stored out of the way.

FIG. 3 shows an enlargement of the elements described in this invention. The shock absorber is in place at a typical location.

FIG. 4 shows an embodiment where the shock absorber removed, and a solid bar put in its place. This in effect solidifies the rear frame to the front frame, and therefore there is no movement of the rear frame that can absorb pedaling energy.

FIG. 5 shows an embodiment where the shock absorber remains in place, but a solid piece is installed separate from the shock absorber. This allows the insertion and removal of the solid piece without disturbing the location of the shock absorber.

FIG. 6 shows an embodiment where the shock absorber is allowed to operate normally while the lockout mechanism still remains attached to the bicycle, but no longer operates in a lockout mode.

FIG. 7 shows an embodiment where a damping adjustment 714 is included in the shock absorber 702. This adjustment allows the damping coefficient to be adjusted to stiffen or lessen the damping effect so as to control the shock absorber movement.

Because there are many styles and types of rear bicycle suspensions, a lockout mechanism may have to be customized for the said type or model of bicycle. Also, a lockout and suspension package may be designed as an alternative for a particular type or style of suspension.

The lockout mechanism may take on several forms. One may require getting off the bicycle and bolting the lockout in place. This may require basic tools such as screwdriver, pliers, or wrench. Another approach may include a latch-in mechanism, where the rider may be able to secure the latch while still on the bicycle. Still another approach may include a latching system where the lockout may be completely removed from the bicycle and stored elsewhere, therefore lessening the total weight of the bicycle. In yet another embodiment the shock absorber and its accompanying weight could be completely removed and a lockout or solid bar be put in its place.

### DETAILED DESCRIPTION

In a bicycle design with a solid frame, there is no movement of the rear frame and the bicycle becomes a solid unit, moving with each bump or irregularity on the road surface. When a shock absorbing suspension system is introduced to a bicycle, the rear wheel and structure of the bicycle moves in an arc like motion against the suspension system. This allows the wheels to move up and down to absorb bumps while keeping the tires in contact with the ground, giving better control and protecting the rider from feeling every bump and dip during a ride over rough terrain. The arc motion allows the rear wheel and frame to move without affecting the tension and operation of the chain and sprocket. A coil spring gives resistance against the movement, and allows it to be confined to specified limits. However, a spring by itself does not absorb energy and it allows bounce. Therefore an energy absorption and dampening mechanism needs to be added. The shock absorber fills this need. It is typically an oil filled device used to dissipate the kinetic energy that is transferred to the bicycle and rider when a bump or other irregularity in the road surface is encountered. The oil transfers through a precise orifice to control the rate of movement and deceleration. Some shock absorbers utilize a pneumatic or air movement design.

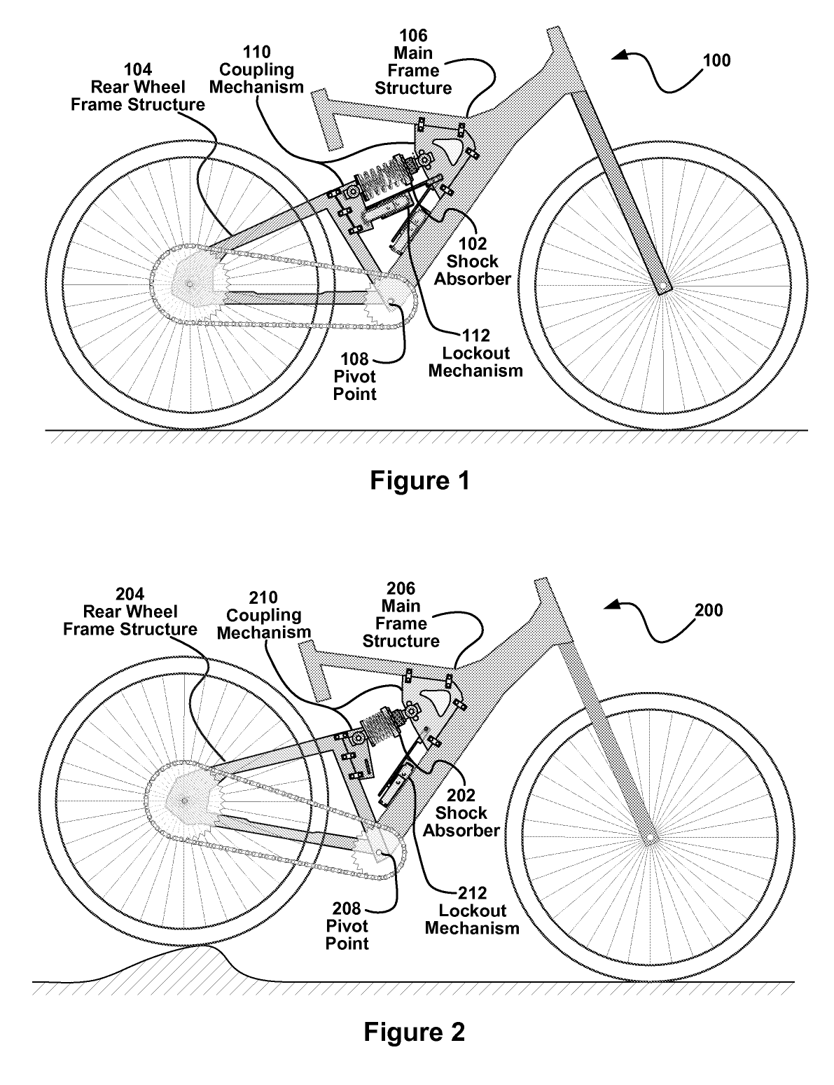

FIG. 1 represents the layout of a typical bicycle and identifies the main components that will be discussed. 100 contains the frame 106, the rear frame 104, a coupling mechanism 110 attached to the bike frame for mounting a shock absorber, the placement of a shock absorber 102, a lockout mechanism 112, and a pivot point 108 where the main and rear frame structures can rotate or move. The coupling mechanism 110 may be built into the bike frame, or it may be a separate, add-on piece. If it is separate, it may be bolted, screwed, or latched on to the front and rear frames. It could also be welded on, making it a permanent part of the frame. This coupling mechanism 110 may also be used to mount a lockout mechanism 112. This may take on several different forms and be mounted in different configurations.

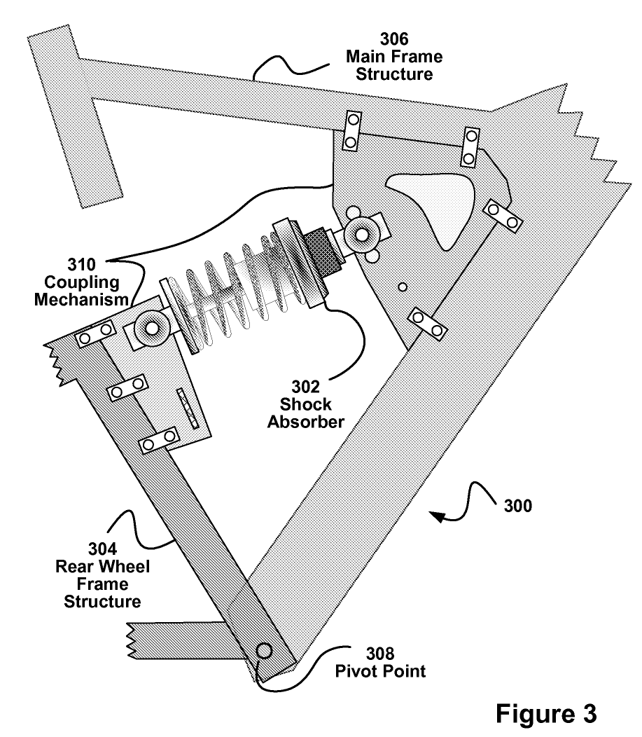

FIG. 2 illustrates the compression of the shock absorber 202 when the rear wheel hits a bump in the road. The shock absorber and spring 202 compress when a bump in the road is encountered, absorbing the bumps and irregularities on the road. As the spring is compressed, energy is absorbed in the shock absorber, “smoothing” the ride for the rider. The reverse is true when a dip in the road is encountered. This allows the rider to maintain a greater control of the bike over rough surfaces and also allows a more comfortable ride. As the whole rear frame 204 and rear wheel assembly move on the pivot point 208, an arc like motion is maintained so the tension and operation of the chain and sprocket are not affected. The movement pushes against the suspension system where the spring and shock absorber 202 control the rate, distance and damping of the arc motion.

In the above case, the lockout mechanism 212 is either not present or is set so that it does not affect the shock absorber 202 operation. The lockout mechanism 212 and the shock absorber 202 are mounted to a coupling mechanism 210. This mechanism can be bolted to, screwed to, latched to, or welded to the bike frame. Or it could be part of the bike frame design. The subject of this invention will deal with the design and mounting of this lockout device.

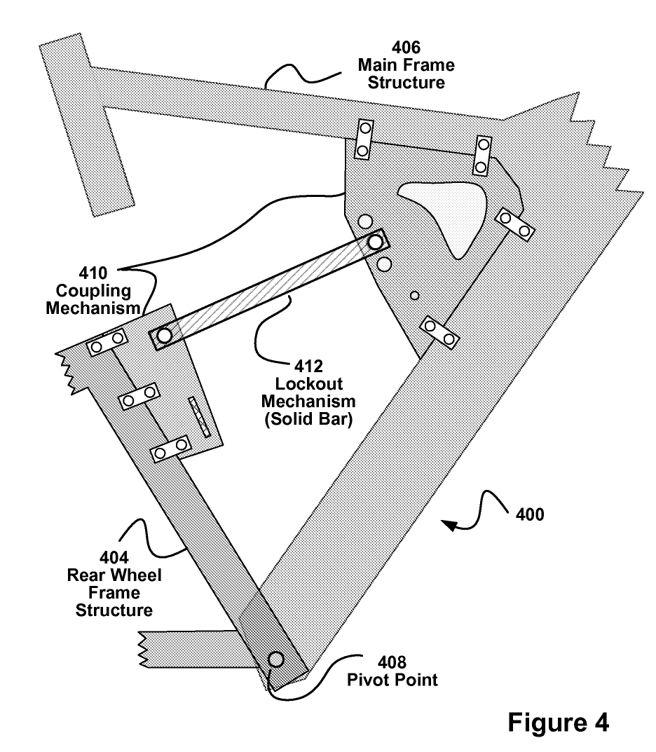

FIG. 3 shows an embodiment giving a more detailed view of the elements described in this invention. In this embodiment the shock absorber 302 is in place in a typical application. It is free to perform its function within the limits of its design without restriction or other outside influences. However, it may also allow the compression and expansion of the shock absorber mechanism 302 during heavy pedaling, where that energy is not utilized in moving the bicycle. In this layout, the shock absorber could be removed and replaced by a solid structure if the mounting of this structure exactly matched the mount points of the shock absorber. In this embodiment, the coupling mechanism 310 and the shock absorber 302 are needed to structurally tie the main frame 306 and rear frame 304 together for proper bike operation. If they were removed, another structural member would have to be added to the bike frame. This invention describes a means of utilizing both a lockout mechanism and a shock absorber in various configurations and means.

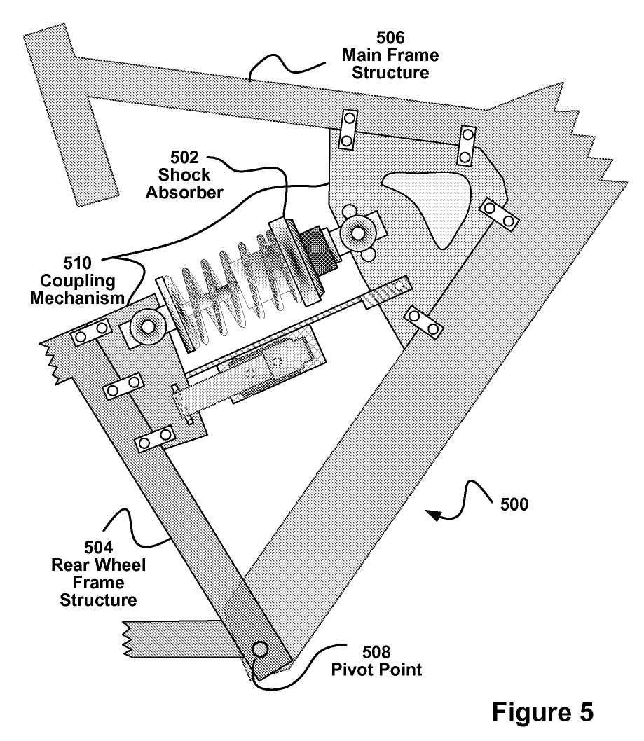

FIG. 4 shows an embodiment 400 where the lockout mechanism 412 is a solid bar which replaces the shock absorber. Thus the energy that would normally be transferred to the shock absorber during heavy pedaling would not be lost. The solid bar 412 can be designed to fit in place of the shock absorber, and use the existing mount points of the shock absorber on the coupling mechanism 410. Thus no other modifications to the bicycle would be required. The mounting mechanism may be bolted, screwed, latched or otherwise inserted in place, utilizing the mounting arrangement normally occupied by the shock absorber. In another embodiment the solid bar could have its own mounting location, negating the need to remove the shock absorber.

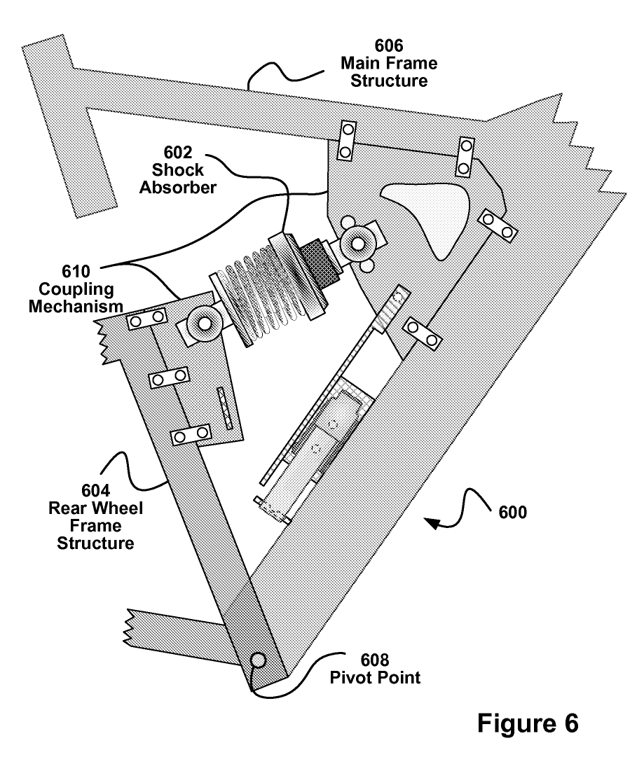

FIG. 5 shows an embodiment where the shock absorber 502 remains in place, but a lockout mechanism 512 renders the shock absorber inoperative. The coupling mechanism 510 contains a mount for the lockout mechanism 512 that is separate from that of the shock absorber 502. The mounting of this mechanism is represented by a bolted or pinned mount point on one end and a latch keeper on the other. In another embodiment, both ends of the lockout mechanism 512 could be latched allowing the whole removal of the lockout without tools. When the lockout mechanism is removed, the shock absorber 502 will operate normally. The latch shown is an over center latch and a “keeper” would be placed on the mounting surface. In another embodiment, the lockout mechanism 512 may be bolted or screwed in place, requiring the use of basic tools such as screwdriver, pliers, or wrench.

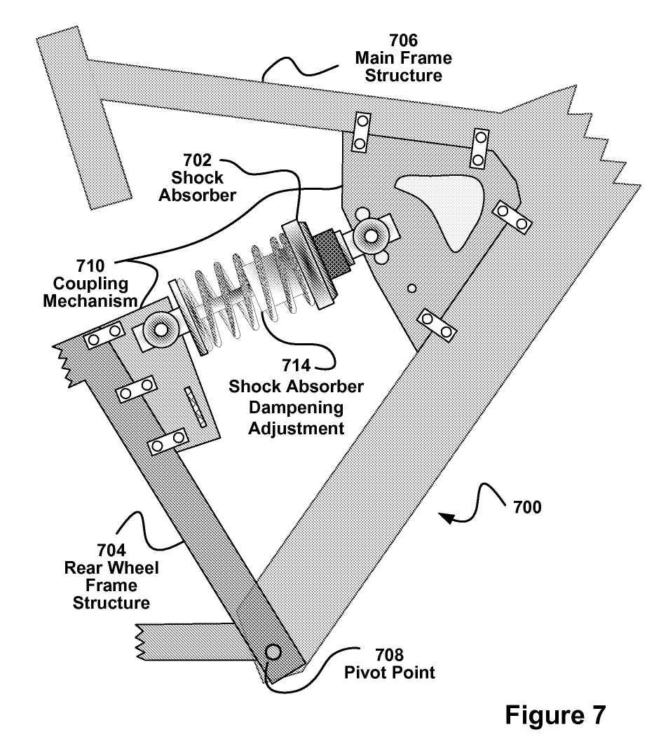

FIG. 6 shows an embodiment where the lockout mechanism 612 is disconnected and out of the way, but still coupled to the coupling mechanism 610. The shock absorber 602 is allowed to operate normally. In this case, the lockout 612 would be positioned out of the way and secured to another latch keeper, requiring no tools. The lockout mechanism 612 can be secured by a variety of ways when it is in non-use. It could be completely removed and stored in a remote location, or it could be secured in an “out of the way” position as shown, allowing a quick reconnect when it is needed. The lockout 612 could be attached and removed in a variety of ways of bolting screwing and latching, some requiring tools and others not requiring tools

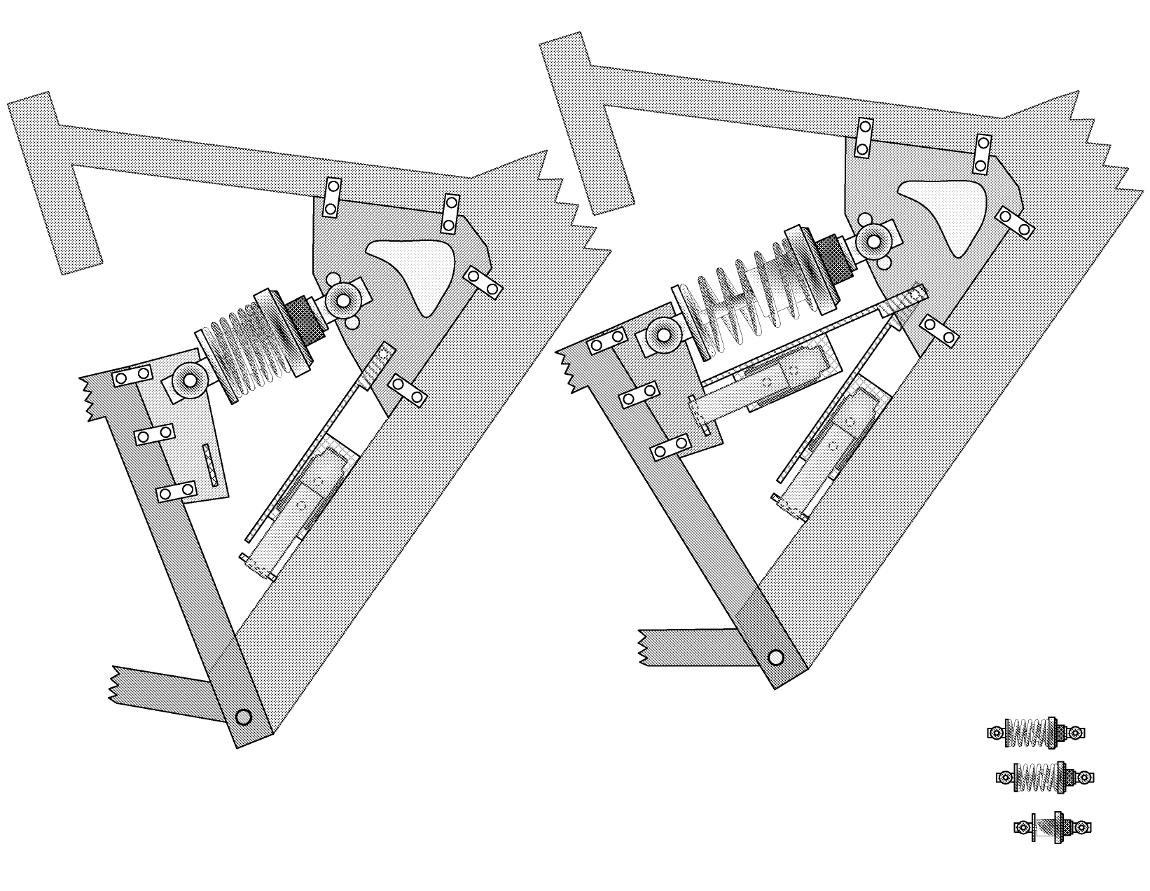

FIG. 7 shows an embodiment where a damping adjustment 714 is included in the shock absorber 702. This adjustment allows the damping coefficient to be adjusted to stiffen or lessen the damping effect so as to control the shock absorber movement. The damping adjustment may be manual and hand controlled. The shock absorber may contain a dual mechanism with two damping coefficients. It may be electrically or hydraulically controlled where the adjustments are manually selected for a specified road or situation requirement. The adjustment also could be automatically controlled wherein adjustments are made for varying road conditions. A stiffened adjustment could be used to lessen the effect of the shock absorber, thus increasing the pedaling efficiency without the full effect of inserting a lockout mechanism. Also, a softening of the adjustment may allow a smoother ride if that condition is desired.

1. A bike frame system comprising:
a bike frame; and
a rear shock coupling mechanism capable of mechanically coupling a shock to the bike frame, the rear shock coupling mechanism being configured such that the shock is capable of being removed for an insertion of a lockout mechanism.

2. The system of claim 1, wherein the rear shock coupling mechanism is configured such that the lockout mechanism is capable of replacing the shock.

3. The system of claim 1, wherein the rear shock coupling mechanism is configured such that the lockout mechanism is capable of sliding in, in place of the shock.

4. The system of claim 1, wherein the rear shock coupling mechanism is configured such that the lockout mechanism is capable of being latched in, in place of the shock.

5. The system of claim 1, wherein the rear shock coupling mechanism is configured such that the lockout mechanism is capable of being screwed in, in place of the shock.

6. The system of claim 1, wherein the rear shock coupling mechanism is configured such that the lockout mechanism is capable of being bolted in, in place of the shock.

7. The system of claim 1, wherein the rear shock coupling mechanism is configured such that the lockout mechanism is capable of being inserted in place of the shock without using tools.

8. The system of claim 1, wherein the rear shock coupling mechanism is configured such that the lockout mechanism is capable of being inserted in place of the shock without using any other mechanism other than the rear shock coupling mechanism.

9. The system of claim 1, further comprising a mechanism for coupling one of the shock or the lockout mechanism to the bike frame when the one of the shock or the lockout mechanism is not coupled to the rear shock coupling mechanism.

10. The system of claim 1, wherein the bike frame is configured to include a mechanism for coupling the shock and/or the lockout mechanism to the bike frame.

11. The system of claim 1, wherein the rear shock coupling mechanism is configured to include a mechanism for coupling the shock and/or the lockout mechanism to the bike frame.

12. The system of claim 1, wherein the rear shock coupling mechanism includes at least one clasp.

13. The system of claim 1, wherein the rear shock coupling mechanism includes at least one pin.

14. The system of claim 1, wherein the rear shock coupling mechanism includes at least one nut and bolt.

15. The system of claim 1, wherein the lockout mechanism includes a first damping mechanism with a first damping coefficient and the shock includes a second damping mechanism with a second damping coefficient that is less than the first damping coefficient.

16. The system of claim 1, wherein a damping coefficient may be adjusted to stiffen or soften the shock absorber action.

17. The system of claim 1, wherein the rear shock coupling mechanism is configured such that the lockout mechanism is capable of being inserted in place of the shock by a person, without the use of tools.

18. The system of claim 1, wherein the rear shock coupling mechanism is mounted on the bike frame.

19. The system of claim 1, wherein the rear shock coupling mechanism is part of the bike frame.

20. A method, comprising:
providing a bike frame; and
providing a rear shock coupling mechanism capable of mechanically coupling a shock to the bike frame, the rear shock coupling mechanism being configured such that the shock is capable of being removed for an insertion of a lockout mechanism,

21. An apparatus, comprising:
a rear shock coupling mechanism capable of mechanically coupling a shock to a bike frame, the rear shock coupling mechanism being configured such that the shock is capable of being removed for an insertion of a lockout mechanism.
